(19) United States
(12) Patent Application Publication
(10) Pub. No.: US 2016/0376416 A1
(43) Pub. Date: Dec. 29, 2016

(54) SILVER CLAY

(71) Applicants: WEI-NUNG CHEN, TAINAN CITY (TW); SOLAR APPLIED MATERIALS TECHNOLOGY CORP., TAINAN CITY (TW)

(72) Inventor: WEI-NUNG CHEN, TAINAN CITY (TW)

(21) Appl. No.: 14/748,915

(22) Filed: Jun. 24, 2015

(51) Int. Cl. C08K 3/08; C08K 5/04; C08K 9/10; C22C 5/06; C08K 7/18

(52) U.S. Cl. CPC C08K 3/08; C22C 5/06; C08K 7/18; C08K 9/10; C08K 5/04; C08K 2003/0806

(57) ABSTRACT

Provided is a silver clay, comprising spherical silver powders, flaky silver powders, a binding agent, and oil. The amount of the spherical and flaky silver powders relative to the total amount of the silver clay ranges from 50 wt % to 96 wt %. The silver clay of said composition improves moisture retention and workability and reduces shrinkage percentage during sintering, thereby improving the performance of a sintered body formed therefrom.

### BACKGROUND OF THE INVENTION

1. Field of the Invention

The present invention relates to a silver clay, more particularly to a silver clay for art craft articles, ornaments, and accessories.

2. Description of the Prior Arts

Due to the inferior heating efficiency and temperature regulation, the small electric furnace cannot effectively control its interior temperature, and thus fails to sinter the whole silver clay. As disclosed by Taiwan Patent No. 584613, the inventors of the prior art modify the composition of the silver clay, which includes 15 wt % to 50 wt % of spherical silver powders having average particle size less than 2 micrometers, 50 wt % to 85 wt % of atomized silver powders having average particle size in a range from 2 micrometers to 100 micrometers, and an organic binding agent, for ensuring the silver clay is fully sintered at a temperature lower than the melting point of pure silver, i.e., from 550° C. to 710° C. Also, the sintered body made from sintering the silver clay at low temperature can have a desired tensile strength and density. However, no technical manner to improve the moisture retention of the silver clay is disclosed in the prior art.

In view that the dried silver clay cannot be softened or reused for shaping, the inventors of Taiwan Patent No. I354656 disclose a silver clay comprised of viscous silver powders, a fluxing agent, an oxidizing agent, an adhesive agent, and a water retaining agent. Said viscous silver powders are comprised of silver particles having particle sizes of 5 micrometers and viscous substances, such as alkyl mercaptan and poly(vinylpyrrolidinone), covering the silver particles. With the use of the water retaining agent, the silver clay can obtain the hydrophilic and softening characteristics, such that the dried silver clay can be softened for modeling after adding water in the dried silver clay. However, said water retaining agent decreases the strength and pull force of the sintered body made from the silver clay and the addition of various additives is apt to increase the impurities contained in the silver clay, both deteriorating the characteristics of the sintered body.

### SUMMARY OF THE INVENTION

In view of the drawbacks of the conventional silver clay, one objective of the present invention is to improve the moisture retention and the shape workability.

Another objective of the present invention is to reduce the shrinkage percentage of the silver clay caused by sintering.

Further another objective of the present invention is to increase the pull strength of the sintered article made from the silver clay.

To achieve the foresaid objectives, the present invention provides a silver clay which comprises spherical silver powders, flaky silver powders, 3 percent by weight (wt %) to 49.99 wt %, inclusive, of a binding agent, and 0.01 wt % to 1 wt %, inclusive, of oil based on a total amount of the spherical silver powders, the flaky silver powders, the binding agent, and the oil. A total amount of the spherical silver powders and the flaky silver powders ranges from 50 wt % to 96 wt %, inclusive, based on the total amount of the spherical silver powders, the flaky silver powders, the binding agent, and the oil.

Preferably, the total amount of the spherical silver powders and the flaky silver powders ranges from 70 wt % to 96 wt %, inclusive, the amount of the binding agent ranges from 3.95 wt % to 29.99 wt %, inclusive, and the amount of the oil ranges from 0.01 wt % to 0.05 wt %, inclusive, based on the total amount of the spherical silver powders, the flaky silver powders, the binding agent, and the oil.

More preferably, the total amount of the spherical silver powders and the flaky silver powders ranges from 80 wt % to 96 wt %, inclusive, the amount of the binding agent ranges from 3.95 wt % to 19.95 wt %, inclusive, and the amount of the oil ranges from 0.01 wt % to 0.05 wt %, inclusive, based on the total amount of the spherical silver powders, the flaky silver powders, the binding agent, and the oil.

Further more preferably, the total amount of the spherical silver powders and the flaky silver powders ranges from 85 wt % to 91 wt %, inclusive, the amount of the binding agent ranges from 8.95 wt % to 14.95 wt %, inclusive, and the amount of the oil ranges from 0.01 wt % to 0.05 wt %, inclusive, based on the total amount of the spherical silver powders, the flaky silver powders, the binding agent, and the oil.

Accordingly, the silver clay of the said composition incurs less shrinkage during sintering, and the sintered body made from the silver clay thus provides an improved pull force.

Preferably, the weight ratio of the spherical silver powders relative to the flaky silver powders ranges from 1:4 to 4:1; more preferably, ranges from 3:7 to 7:3; further more preferably, ranges from 2:3 to 3:2; and still further more preferably, ranges from 1:1 to 3:2. By controlling the weight ratio of the spherical silver powders relative to the flaky silver powders, the silver clay is sintered to form a sintered body with reduced shrinkage percentage and improved pull strength.

Said spherical silver powders can be optionally modified with surface treatment, and so do the flaky silver powders. Preferably, the spherical silver powders comprise original spherical silver powders without surface treatment, surface-treated spherical silver powders or their combination, and the flaky silver powders comprise original flaky silver powders without surface treatment, surface-treated flaky silver powders or their combination.

Preferably, the spherical silver powders are composed of the original spherical silver powders without surface treatment and the surface-treated spherical silver powders with a ratio from 4:6 to 6:4 by weight, and the flaky silver powders are composed of the original flaky silver powders without surface treatment and the surface-treated flaky silver powders with a ratio from 4:6 to 6:4 by weight.

Preferably, said spherical silver powders comprise a dispersant and silver spheres coated with the dispersant, and said flaky silver powders comprise a dispersant and silver flakes coated with the dispersant. The dispersant of the spherical silver powders and the dispersant of the flaky silver powders may independently be lauric acid, myristic acid, oleic acid, stearic acid, behenic acid, ammonium oleate, methyl oleate, sodium salt of polynaphthalene sulfonate, or any combinations thereof. The dispersant has superior effects of moisture retention, softness, and moldability, thereby improving the shape workability of the silver clay.

Preferably, the spherical silver powders have particle sizes ranging from 0.1 micrometers to 5 micrometers, and the flaky silver powders have lengths ranging from 1 micrometer to 20 micrometers.

Preferably, the spherical silver powders have a specific surface area ranging from 0.1 m²/g to 10 m²/g, and the flaky silver powders have a specific surface area ranging from 0.2 m²/g to 10 m²/g.

The oil comprised in the silver clay may be vegetable oil, animal oil, stearic acid or palmitic acid. More specifically, the applicable vegetable oil may be, but not limited to, olive oil, corn oil, soy oil, coconut oil, palm oil, sunflower oil, sesame oil, or cotton seed oil.

Said binding agent comprises water and cellulose, and the weight ratio of water relative to the cellulose ranges from 5:1 to 15:1. The cellulose comprised in the binding agent of the silver clay may be lignocellulose, methyl cellulose, or carboxymethyl cellulose.

Other objectives, advantages and novel features of the invention will become more apparent from the following detailed description when taken in conjunction with the accompanying drawings.

### BRIEF DESCRIPTION OF THE DRAWINGS

FIG. 1 is a scanning electron microscope image of silver spheres.

FIG. 2 is a scanning electron microscope image of silver flakes.

### DETAILED DESCRIPTION OF THE PREFERRED EMBODIMENTS

Hereinafter, one skilled in the arts can easily realize the advantages and effects of a silver clay in accordance with the present invention from the following examples. It should be understood that the descriptions proposed herein are just preferable examples only for the purpose of illustrations, not intended to limit the scope of the invention. Various modifications and variations could be made in order to practice or apply the present invention without departing from the spirit and scope of the invention.

### Preparation Examples 1 to 5

Raw materials used in Preparation Examples 1 to 5 included spherical silver powders and flaky silver powders, both were surface-treated with dispersant.

Said spherical silver powders were commercially available as “SP03” from Solar Applied Materials Technology Corporation, which comprised silver spheres coated with oleic acid. The spherical silver powders had particle sizes within a range from 0.1 micrometers to 5 micrometers, a median particle size (D50) about 0.7 micrometers, and a specific surface area within a range from 0.1 m²/g to 10 m²/g.

To determine the loss on ignition (LOI) percentages of the commercially available samples, taken spherical silver powders as an example, the spherical silver powders dried at 100° C. for 1 hour were placed in a crucible, which had been pre-heated at 1000° C. for 1 hour and cooled, and then weighed to obtain the mass of the spherical silver powders before decomposition. The weighed spherical silver powders in the crucible were heated from 200° C. to 1000° C. and maintained for additional 5 hours in a furnace, then cooled down to 200° C. and weighed, so as to obtain the mass of the spherical silver powders after decomposition.

The LOI of sample was calculated by the equation as follows:

LOI (%)=(m0−m1)/m0×100%

where

m0 represented mass of the sample before decomposition; and

m1 represented mass of the sample after decomposition.

According to the foresaid method, the spherical silver powders were determined to have an LOI of 0.2%. Said LOI represented the amount of the oleic acid contained in the commercially available spherical silver powders.

Said flaky silver powders were commercially available as “SG00A3” from Solar Applied Materials Technology Corporation, which comprised silver flakes coated with oleic acid. The flaky silver powders had lengths within a range from 2 micrometers to 20 micrometers, a median length about 3.7 micrometers, a specific surface area within a range from 0.2 m²/g to 10 m²/g, and an LOI of 0.2% determined by the foresaid method.

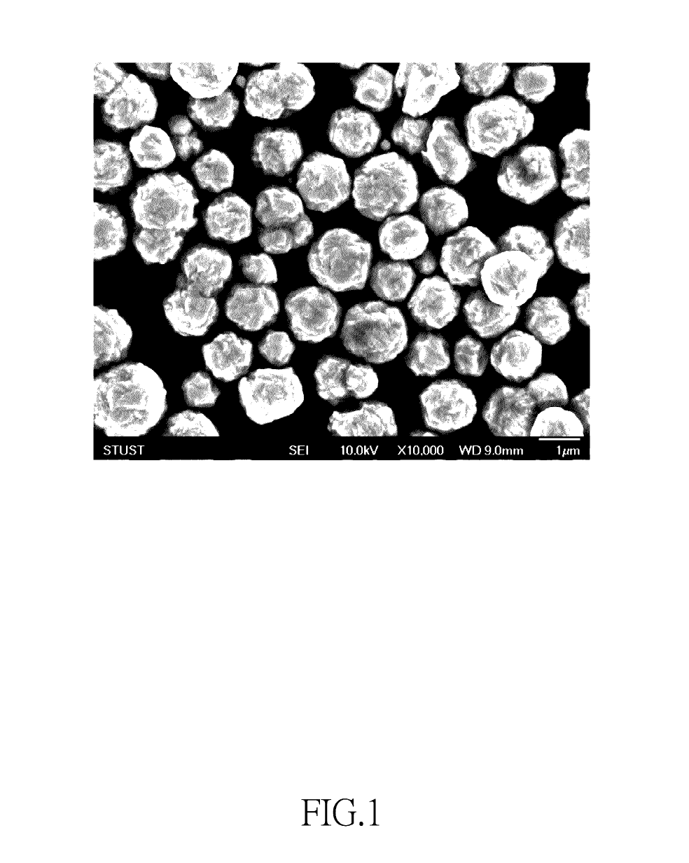

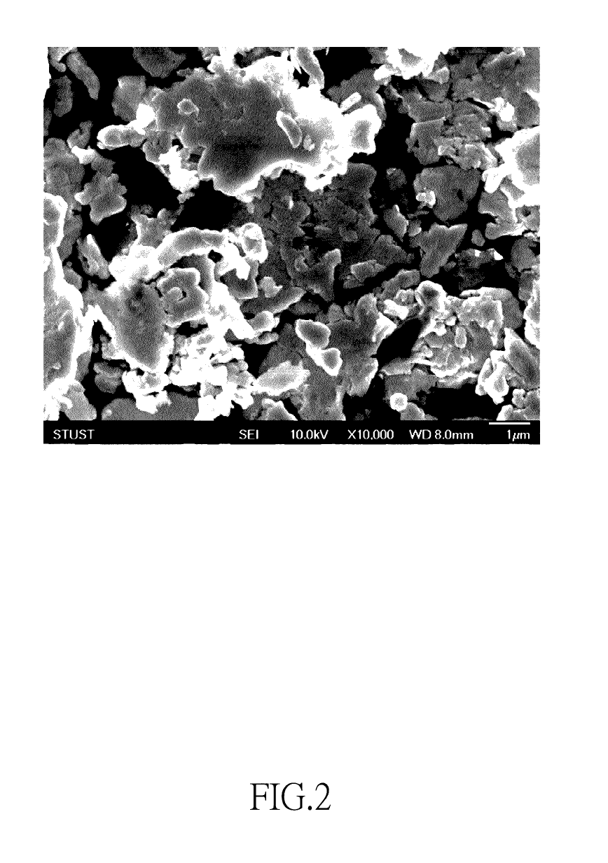

The morphologies of the silver spheres and the silver flakes were observed under a scanning electron microscope. As shown in FIGS. 1 and 2, the silver spheres had particle sizes of 0.1 micrometers to 5 micrometers, and the silver flakes had lengths of 2 micrometers to 20 micrometers and an aspect ratio, i.e., length-to-thickness ratio, of 1 to 20.

The commercially available spherical silver powders and the commercially available flaky silver powders were respectively mixed with various ratios listed in Table 1, so as to prepare the silver mixed powders of Preparation Examples 1 to 3, the spherical silver powders of Preparation Example 4, and the flaky silver powders of Preparation Example 5.

### Preparation Example 6

Raw materials used in Preparation Example 6 included the commercially available spherical silver powders (SP03), commercially available flaky silver powders (SG00A3), the silver spheres without surface treatment (original spherical silver powders), and the silver flakes without surface treatment (original flaky silver powders). Said commercially available spherical silver powders and commercially available flaky silver powders had characteristics as stated above. The silver spheres and silver flakes without surface treatment were not coated with oleic acid, and thus both had LOI percentages of 0% determined by the foresaid method. The silver spheres had particle sizes within a range from 0.1 micrometers to 5 micrometers, D50 about 0.7 micrometers, and a specific surface area within a range from 0.1 m²/g to 10 m²/g. The silver flakes had lengths within a range from 2 micrometers to 20 micrometers, a median length about 3.7 micrometers, and a specific surface area within a range from 0.2 m²/g to 10 m²/g.

The spherical silver powders, composed of the commercially available spherical silver powders and the silver spheres without surface treatment in a 1:1 ratio by weight, were mixed with the flaky silver powders, composed of the commercially available flaky silver powders and silver flakes without surface treatment in a 1:1 ratio by weight, to prepare the silver mixed powders of Preparation Example 6.

As shown in Table 1, the total amount of the commercially available spherical silver powders and the silver spheres without surface treatment was 50 wt % and the total amount of the commercially available flaky silver powders and the silver flakes without surface treatment was 50 wt % based on the total amount of the silver mixed powders.

The silver mixed powders of Preparation Examples 1 to 3 and 6, the spherical silver powders of Preparation Example 4, and the flaky silver powders of Preparation Example 5 were analyzed with a tap density/bulk density analyzer (Autotap/Dual Autotap) to measure the tap density of the powder samples. 10 grams of powder sample was placed in a volumetric cylinder and tapped 3000 times, and then the height of the tapped sample was observed to determine the tap density. Results of the tap density were listed in Table 1.

TABLE 1
amounts of spherical silver powders and flaky silver powders of the
silver mixed powders of Preparation Examples 1 to 3 and 6, the spherical
silver powders of Preparation Example 4, and the flaky silver powders
of Preparation Example 5 and their tap densities (unit: g/cm³)

| | Amount of | Amount of | |
|---|---|---|---|
| | flaky silver | spherical silver | |
| Sample No. | powders | powders | Tap density |
| Preparation Example 1 | 20 wt % | 80 wt % | 3.9 g/cm³ |
| Preparation Example 2 | 30 wt % | 70 wt % | 4.4 g/cm³ |
| Preparation Example 3 | 50 wt % | 50 wt % | 4.8 g/cm³ |
| Preparation Example 4 | 0 wt % | 100 wt % | 3.4 g/cm³ |
| Preparation Example 5 | 100 wt % | 0 wt % | 3.7 g/cm³ |
| Preparation Example 6 | 50 wt % | 50 wt % | 4.8 g/cm³ |

### Examples 1 to 9

### Silver Clay

Silver raw materials used in Examples 1 to 9 included the silver mixed powders prepared from Preparation Examples 1 to 3 and 6. Said silver mixed powders were mixed with a binding agent and vegetable oil according to the ratios as listed in Table 2, to obtain the silver clay of Examples 1 to 9. Said binding agent included water and lignocellulose with a ratio of 10:1 by weight. The vegetable oil used in the Examples 1 to 9 were olive oil.

The sample numbers of silver mixed powders used in Examples 1 to 9 and the amounts of the silver mixed powders, the binding agent, and the vegetable oil were listed in Table 2. The listed amounts were calculated on the basis of the total amount of the silver mixed powders, the binding agent, and the vegetable oil.

TABLE 2
sample numbers of silver mixed powders and the respective
amounts of the silver mixed powders, the binding agent,
and the vegetable oil in Examples 1 to 9

| Sample No. | | Respective amount | | |
|---|---|---|---|---|
| | Silver mixed | Silver mixed | Binding | Vegetable |
| Silver clay | powders | powders | agent | oil |
| Example 1 | Preparation | 90 wt % | 9.98 wt % | 0.02 wt % |
| | Example 1 | | | |
| Example 2 | Preparation | 90 wt % | 9.98 wt % | 0.02 wt % |
| | Example 2 | | | |
| Example 3 | Preparation | 90 wt % | 9.98 wt % | 0.02 wt % |
| | Example 3 | | | |
| Example 4 | Preparation | 96 wt % | 3.98 wt % | 0.02 wt % |
| | Example 3 | | | |
| Example 5 | Preparation | 90 wt % | 9.98 wt % | 0.02 wt % |
| | Example 3 | | | |
| Example 6 | Preparation | 70 wt % | 29.98 wt % | 0.02 wt % |
| | Example 3 | | | |
| Example 7 | Preparation | 50 wt % | 49.98 wt % | 0.02 wt % |
| | Example 3 | | | |
| Example 8 | Preparation | 90 wt % | 9.98 wt % | 0.02 wt % |
| | Example 3 | | | |
| Example 9 | Preparation | 90 wt % | 9.98 wt % | 0.02 wt % |
| | Example 6 | | | |

### Comparative Example 1

### Silver Clay

Silver raw material used in Comparative Example 1 was consisted of the spherical silver powders from Preparation Example 4. Said spherical silver powders were mixed with a binding agent, including 10:1 of water and lignocellulose by weight, and olive oil to obtain the silver clay of Comparative Example 1. The amounts of the spherical silver powders, the binding agent, and the vegetable oil were 90 wt %, 9.98 wt %, and 0.02 wt %, respectively.

### Comparative Example 2

### Silver Clay

Silver raw material used in Comparative Example 2 was consisted of the flaky silver powders from Preparation Example 5. Said flaky silver powders were mixed with a binding agent, including 10:1 of water and lignocellulose by weight, and olive oil to obtain the silver clay of Comparative Example 2. The amounts of the flaky silver powders, the binding agent, and the vegetable oil were 90 wt %, 9.98 wt %, and 0.02 wt %, respectively.

### Comparative Example 3

### Silver Clay

Silver raw material used in Comparative Example 1 included the silver spheres and the silver flakes, both were not surface treated with the oleic acid. The LOI percentage of silver spheres without surface treatment was 0%. The silver spheres had particle sizes within a range from 0.1 micrometers to 5 micrometers, D50 about 0.7 micrometers, and a specific surface area within a range from 0.1 m²/g to 10 m²/g. The LOI percentage of silver flakes without surface treatment was also 0%. The silver flakes had lengths within a range from 2 micrometers to 20 micrometers, a median length about 3.7 micrometers, and a specific surface area within a range from 0.2 m²/g to 10 m²/g.

Said silver spheres and silver flakes without surface treatment were mixed with a binding agent, including 10:1 of water and lignocellulose by weight, and olive oil to obtain the silver clay of Comparative Example 3. The total amount of the silver spheres and silver flakes was 90 wt %, and the respective amounts of the binding agent and the vegetable oil were 9.98 wt % and 0.02 wt %, respectively.

### Test Example 1

### Thrust Force

In Test Example 1, silver clays prepared from Examples 1 to 3 and Comparative Example 1 were each shaped into cylindrical samples with a diameter of 0.5 centimeters and a length of 3 centimeters. The cylindrical sample was set at 40° C. and 40% of humidity for 20 minutes, and then held on a holder with an exposed length of 0.5 centimeters to measure the thrust force of the sample with a tension gauge (DT-500, manufactured by TECLOCK).

The larger thrust force represented the higher surface hardness, indicating that the silver clay is dried more quickly when setting for a period. Results of the thrust forces of the samples were listed in Table 3.

### Test Example 2

### Breaking Length

In Test Example 2, silver clays prepared from Examples 1 to 3 and Comparative Example 1 were each shaped into cylindrical samples with a diameter of 0.3 centimeters and a length of 3 centimeters. The cylindrical sample was set at 21° C. and 65% of humidity for 30 minutes, and then extended to failure with a horizontal tensile tester (JSH-H1000, manufactured by JISC) at a extension rate of 60 mm/min, so as to measure the breaking length.

The longer breaking length represented the better ductility, showing that the silver clay is dried more slowly when setting for a period. Results of the breaking lengths of the samples were also listed in Table 3.

TABLE 3
the thrust force (unit: kilogram force (kgf)) and the
breaking length (unit: centimeters) of the silver clays
of Examples 1 to 3 and Comparative Example 1

| Sample No. | Thrust force | Breaking length |
|---|---|---|
| Example 1 | 0.12 kgf | 3.6 cm |
| Example 2 | 0.09 kgf | 3.6 cm |
| Example 3 | 0.08 kgf | 3.6 cm |
| Comparative Example 1 | 0.23 kgf | 3.1 cm |

As shown in Table 3, the thrust force of the silver clay of Comparative Example 1 was obviously higher than those of Examples 1 to 3, and the breaking length of the silver clay of Comparative Example 1 was shorter than those of Examples 1 to 3. That is, the silver clay merely containing the spherical silver powders and lacking the flaky silver powders, i.e., the silver clay of Comparative Example 1, was dried much more quickly than the silver clays containing both spherical silver powders and flaky silver clay, i.e., the silver clays of Examples 1 to 3, such that the silver clay of the Comparative Example had a harder surface and thus was not feasible to be shaped compared to those of Examples 1 to 3.

It can be seen that adopting both the spherical and flaky silver powders as the silver raw material slows down the drying of the silver clay and extends the breaking length of the silver clay, such that the silver clays of Examples 1 to 3 can be shaped within a long enough period and has improved moisture retention and shape workability.

More particularly, from the results of Examples 1 to 3, when the difference between the amounts of spherical silver powders and the flaky silver powders is less, the thrust force and the surface hardness of the silver clay are lower, showing that the silver clay is dried more slowly when setting for a period, and thus has a superior shape workability. Accordingly, the silver clay having spherical and flaky silver powders in 1:1 ratio by weight, i.e., the silver clay of Example 3, provides the most feasible shape workability within those of Examples 1 to 3.

### Test Example 3

### Sintering Shrinkage

In Test Example 3, silver clays prepared from Examples 1 to 7 and Comparative Examples 1 and 2 were each shaped into cylindrical samples with a diameter of 0.3 centimeters and a length of 6 centimeters. Said length was the length of sample before sintering, also called the original length. Then the cylindrical samples were each sintered at 650° C. for 30 minutes to prepare the sintered samples. After that, the lengths after sintering of the sintered samples were each recorded, and the sintering shrinkage percentage of the tested samples were each calculated according to the equation as follows:

$$Sintering shrinkage ( \% ) = \frac{Original length - Length after sintering}{Original length} \times 100 \%$$

Results of shrinkage percentage of the samples were listed in Table 4.

### Test Example 4

### Pull Force

In Test Example 4, silver clays prepared from Examples 1 to 7 and Comparative Examples 1 and 2 were each shaped into cylindrical samples with a diameter of 0.3 centimeters and a length of 3 centimeters. The cylindrical samples were each set at 650° C. for 30 minutes to prepare the sintered samples. Then the sintered samples were measured with a tensile tester (3369, manufactured by INSTRON) at an extension rate of 0.1 mm/min, so as to measure the pull force of the sintered samples. Results of the pull forces were listed in Table 4.

TABLE 4
the sintering shrinkage (unit: %) and the pull force
(unit: newton (N)) of the silver clay of Examples 1 to
7 and Comparative Examples 1 and 2 after sintering

| Sample No. | Sintering shrinkage | Pull force |
|---|---|---|
| Example 1 | 3% | 329 N |
| Example 2 | 2.5% | 325 N |
| Example 3 | 3% | 475 N |
| Example 4 | 4% | 452 N |
| Example 5 | 7% | 380 N |
| Example 6 | 19% | 39 N |
| Example 7 | 21% | 31 N |
| Comparative Example 1 | 6.2% | 303 N |
| Comparative Example 2 | 7% | 350 N |

As shown in the above Table 1, the tap densities of silver mixed powders of Preparation Examples 1 to 3 were all higher than that of the spherical silver powders of Preparation Example 4 and that of the flaky silver powders of Preparation Example 5, and the silver mixed powders of Preparation Example 3 had the highest tap density among Preparation Examples 1 to 5.

As shown in Table 2, all mixing ratios of silver mixed powders, binding agent, and vegetable oil among Examples 1 to 3 are identical. However, the silver clays of Examples 1 to 3 incurred less shrinkage after sintering compared with those of Comparative Examples 1 and 2, and the silver clays of Examples 1 to 3 were each made into sintered samples with a higher pull strength compared with those of Comparative Examples 1 and 2. That is, adopting both the spherical and flaky silver powders as the silver raw material and controlling the composition of the silver clay do improve the tap density of the silver mixed powders of the silver clay, reduce the size difference of the sample before and after sintering, i.e., reduce the shrinkage percentage of the silver clay occurred after sintering, and increase the pull strength of the sintered sample.

From the results of Examples 4 to 7 as shown in Table 4, the silver clay containing more spherical silver powders and flaky silver shrank less after sintering, and its sintered sample had a higher pull strength. Accordingly, the silver clay would be formed into a sintered sample with improved performance when the total amount of spherical and flaky silver powders was in a range from 90 wt % to 96 wt % on the basis of the total amount of the spherical and flaky silver powders, the binding agent, and the oil.

### Test Example 5

### Weight Loss

In Test Example 5, silver clays prepared from Examples 8 and 9 and Comparative Example 3 were each used as tested samples and blended at 21° C. and 40% of humidity for 10 minutes. The weights of the tested samples before and after blending were recorded, and calculated according to the following equation to obtain the weight loss, whose unit was percent (%). The larger weight loss represented the faster drying rate of the tested sample, indicating that the silver clay is dried more quickly and thus has an inferior workability.

$$Weight loss ( \% ) = \frac{Original weight - Weight after mixing}{Original weight} \times 100 \%$$

The experimental result showed that the silver clay of Example 8 had 1.05% of weight loss, the silver clay of Example 9 had 1.1% of weight loss, and the silver clay of Comparative Example 3 had 1.5% of weight loss. It can be seen that coating a dispersant such as oleic acid surrounding the spherical and flaky silver powders can decrease the weight loss of the silver clay within a period of drying and slow down the drying rate of the silver clay, thereby rendering the silver clay a superior moisture retention, softness, and moldability. Accordingly, the silver clay containing the silver spheres and the silver flakes both coated with the dispersants has an improved shape workability.

Adopting both spherical and flaky silver powders as the silver raw material and controlling the respective amounts of the spherical and flaky silver powders, the binding agent, and the oil are beneficial to enhance the moisture retention, slow down the drying rate, and improve the shape workability of the silver clay. Further, the decrease of the shrinkage percentage caused by sintering the silver clay and the increase of the pull strength of the sintered sample can be achieved, and the characteristics of the sintered sample made from the silver clay are thus improved by controlling the tap density of the silver mixed powders.

In comparison with the conventional silver clay, the silver clay of the present invention does have improved moisture retention and shape workability on the premise of maintaining the characteristics of its sintered sample, such that the silver clay is more useful to make art craft articles, ornaments, and accessories.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A silver clay, comprising spherical silver powders, flaky silver powders, a binding agent, and oil;
wherein a total amount of the spherical silver powders and the flaky silver powders ranges from 50 percent by weight to 96 percent by weight, inclusive, an amount of the binding agent ranges from 3 percent by weight to 49.99 percent by weight, inclusive, and an amount of the oil ranges from 0.01 percent by weight to 1 percent by weight, inclusive, based on a total amount of the spherical silver powders, the flaky silver powders, the binding agent, and the oil.

2. The silver clay as claimed in claim 1, wherein a weight ratio of the spherical silver powders to the flaky silver powders ranges from 2:3 to 3:2.

3. The silver clay as claimed in claim 1, wherein the total amount of the spherical silver powders and the flaky silver powders ranges from 85 percent by weight to 96 percent by weight, inclusive, the amount of the binding agent ranges from 3.95 percent by weight to 14.95 percent by weight, inclusive, and the amount of the oil ranges from 0.01 percent by weight to 0.05 percent by weight, inclusive, based on the total amount of the spherical silver powders, the flaky silver powders, the binding agent, and the oil.

4. The silver clay as claimed in claim 2, wherein the total amount of the spherical silver powders and the flaky silver powders ranges from 85 percent by weight to 96 percent by weight, inclusive, the amount of the binding agent ranges from 3.95 percent by weight to 14.95 percent by weight, inclusive, and the amount of the oil ranges from 0.01 percent by weight to 0.05 percent by weight, inclusive, based on the total amount of the spherical silver powders, the flaky silver powders, the binding agent, and the oil.

5. The silver clay as claimed in claim 1, wherein the spherical silver powders have particle sizes ranging from 0.1 micrometers to 5 micrometers.

6. The silver clay as claimed in claim 1, wherein the flaky silver powders have lengths ranging from 1 micrometer to 20 micrometers.

7. The silver clay as claimed in claim 5, wherein the flaky silver powders have lengths ranging from 1 micrometer to 20 micrometers.

8. The silver clay as claimed in claim 1, wherein the spherical silver powders comprise a dispersant and silver spheres coated with the dispersant, and the dispersant of the spherical silver powders is selected from the group consisting of lauric acid, myristic acid, oleic acid, stearic acid, behenic acid, ammonium oleate, methyl oleate, sodium salt of polynaphthalene sulfonate, and any combinations thereof.

9. The silver clay as claimed in claim 1, wherein the flaky silver powders comprise a dispersant and silver flakes coated with the dispersant, and the dispersant of the flaky silver powders is selected from the group consisting of lauric acid, myristic acid, oleic acid, stearic acid, behenic acid, ammonium oleate, methyl oleate, sodium salt of polynaphthalene sulfonate, and any combinations thereof.

10. The silver clay as claimed in claim 8, wherein the flaky silver powders comprise a dispersant and a silver flake coated with the dispersant, and the dispersant of the flaky silver powders is selected from the group consisting of lauric acid, myristic acid, oleic acid, stearic acid, behenic acid, ammonium oleate, methyl oleate, sodium salt of polynaphthalene sulfonate, and any combinations thereof.

11. The silver clay as claimed in claim 1, wherein the oil comprises olive oil, corn oil, soy oil, coconut oil, palm oil, sunflower oil, sesame oil, cotton seed oil, stearic oil, or palmitic acid.

12. The silver clay as claimed in claim 1, wherein the binding agent comprises water and cellulose, and the cellulose is selected from the group consisting of lignocelluloses, methyl cellulose, and carboxymethyl cellulose.
